(19) United States
(12) Patent Application Publication
(10) Pub. No.: US 2016/0189178 A1
(43) Pub. Date: Jun. 30, 2016

(54) APPARATUS AND METHOD FOR PREDICTING FUTURE INCREMENTAL REVENUE AND CHURN FROM A RECURRING REVENUE PRODUCT

(71) Applicant: Reveel Inc., San Francisco, CA (US)

(72) Inventors: Amr SHADY, Cairo (EG); Omar Ebn El Khattab Mahmoud Kamal Ahmed Abdelfattah Hosney, Cairo (EG)

(73) Assignee: Reveel Inc.

(21) Appl. No.: 14/699,512

(22) Filed: Apr. 29, 2015

Related U.S. Application Data
(63) Continuation-in-part of application No. 14/587,318, filed on Dec. 31, 2014, now abandoned.

(51) Int. Cl. G06Q 30/02; G06F 17/30

(52) U.S. Cl. CPC G06Q 30/0202; G06F 17/30554; G06F 17/3089

(57) ABSTRACT

The embodiments described herein comprise a prediction engine running on a server for receiving a dataset relating to a recurring revenue product, applying algorithms to the dataset to generate a revenue performance index and a churn performance index, and applying the revenue performance index and churn performance index to a known value to generate a prediction of incremental revenue and incremental churn to be generated in the future from the recurring revenue product.

### PRIORITY CLAIM

This application is a continuation-in-part of U.S. application Ser. No. 14/587,318, filed on Dec. 31, 2014, and titled “Apparatus and Method for Predicting Future Incremental Revenue and Churn From a Recurring Revenue Product,” which is incorporated herein by reference in its entirety.

### TECHNICAL FIELD

The embodiments described herein comprise a prediction engine running on a server for receiving a dataset relating to a recurring revenue product, applying algorithms to the dataset to generate a revenue performance index and a churn performance index, and applying the revenue performance index and churn performance index to a known value to generate a prediction of incremental revenue and incremental churn to be generated in the future from the recurring revenue product.

### BACKGROUND OF THE INVENTION

The prior art includes numerous products that a customer purchases on a recurring revenue basis. For example, home and mobile telephone and data services, video streaming services, and online music are just some of the many products that can be paid for by a customer on a recurring payment basis. Providers of such products often have difficulty predicting how much revenue will be generated from new customers and how much churn (e.g., the termination of a recurring revenue product) will occur. In any given time period, customers may choose to stop receiving the recurring revenue product, or they may choose to continue receiving the recurring revenue product and use a greater or lesser amount of the product. Due to such variability in customer behavior, the provider is often left guessing as to what its future revenue stream from new customers acquired through a marketing activity and any churn will be.

What is needed is a reliable system and method for predicting incremental revenue and churn to be generated in the future based on a known, existing data set. What is further needed it a visualization mechanism for displaying the incremental revenue and churn prediction and related data to a user.

### SUMMARY OF THE INVENTION

The embodiments described herein comprise a prediction engine running on a server for receiving a dataset relating to a recurring revenue product, applying algorithms to the dataset to generate a revenue performance index and a churn performance index, and applying the revenue performance index and churn performance index to a known value to generate a prediction of incremental revenue and incremental churn to be generated in the future from the recurring revenue product.

### BRIEF DESCRIPTION OF THE DRAWINGS

FIG. 1 depicts hardware components of a first computing device and data store.

FIG. 2 depicts software components of the first computing device.

FIG. 3 depicts hardware components of a second computing device.

FIG. 4 depicts software components of the second computing device.

FIG. 5 depicts a prediction engine and display engine operated by the first computing device and a display device operated by the second computing device

FIG. 6 depicts a performance index prediction method.

FIG. 7A depicts a graph of the normalized number of customers over time for a single cohort curve for a specific service.

FIG. 7B depicts a graph of the normalized number of customers over time for all cohorts for a specific service (curves are shifted left and overlapped for ease of comparing).

FIG. 8 depicts mean and standard deviation data for a plurality of services reflected in an input dataset.

FIG. 9 depicts an exemplary input dataset for the computing device.

FIG. 10 depicts a tree structure displaying data generated by a module running on a computing device.

FIG. 11 depicts probabilities generated by a module running on a computing device.

### DETAILED DESCRIPTION OF THE PREFERRED EMBODIMENTS

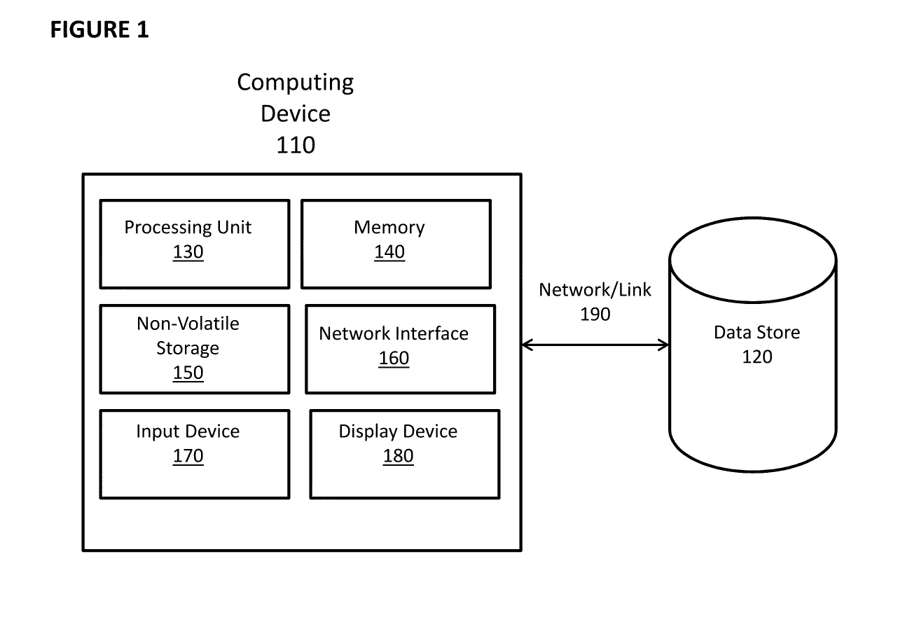

With reference to FIG. 1, computing device 110 is depicted. Computing device 110 can be a server, desktop, notebook, mobile device, tablet, or any other computer with network connectivity. Computing device 110 comprises processing unit 130, memory 140, non-volatile storage 150, network interface 160, input device 170, and display device 180. Non-volatile storage 150 can comprise a hard disk drive or solid state drive. Network interface 160 can comprise an interface for wired communication (e.g., Ethernet) or wireless communication (e.g., 3G, 4G, GSM, 802.11). Input device 170 can comprise a keyboard, mouse, touchscreen, microphone, motion sensor, and/or other input device. Display device 180 can comprise an LCD screen, touchscreen, or other display.

Computing device 110 is coupled (by network interface 160 or another communication port) to data store 120 over network/link 190. Network/link 190 can comprise wired portions (e.g., Ethernet) and/or wireless portions (e.g., 3G, 4G, GSM, 802.11), or a link such as USB, Firewire, PCI, etc. Network/link 190 can comprise the Internet, a local area network (LAN), a wide area network (WAN), or other network.

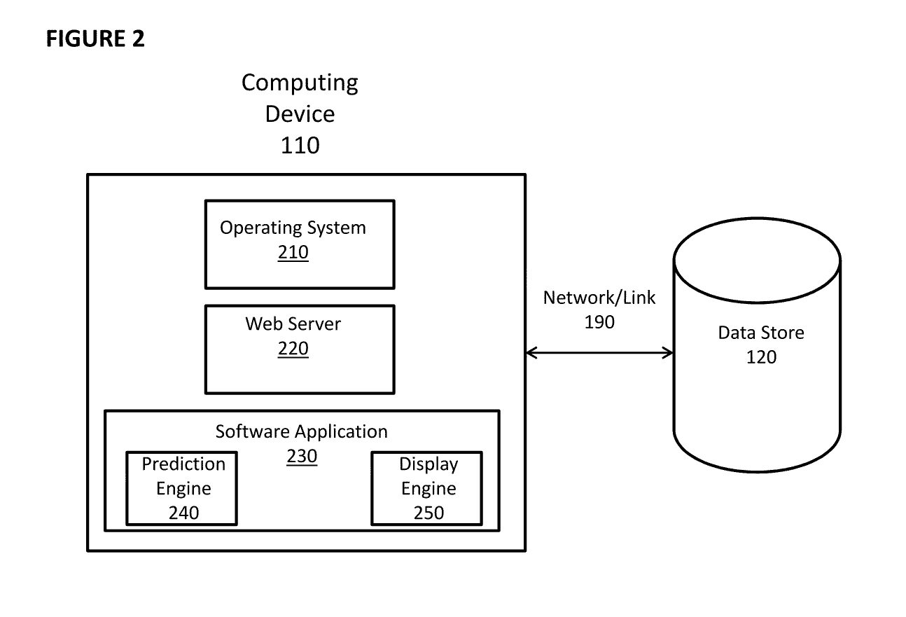

With reference to FIG. 2, software components of computing device 110 are depicted. Computing device 110 comprises operating system 210 (such as Windows, Linux, MacOS, Android, or iOS), web server 220 (such as Apache). and software application 230. Software application 230 comprises prediction engine 240 and display engine 250. Operating system 210, web server 220, and software application 230 each comprise lines of software code that can be stored in memory 140 and executed by processing unit 130 (or plurality of processing units).

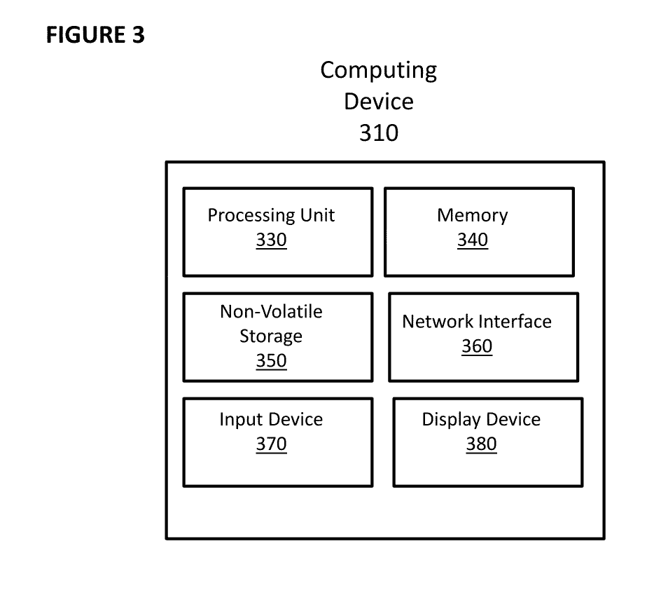

With reference to FIG. 3, another computing device, computing device 110, is depicted. Computing device 310 can be a server, desktop, notebook, mobile device, tablet, or any other computer with network connectivity. Computing device 310 comprises processing unit 330, memory 340, non-volatile storage 350, network interface 360, input device 370, and display device 380. Non-volatile storage 350 can comprise a hard disk drive or solid state drive. Network interface 360 can comprise an interface for wired communication (e.g., Ethernet) or wireless communication (e.g., 3G, 4G, GSM, 802.11). Input device 370 can comprise a keyboard, mouse, touchscreen, microphone, motion sensor, and/or other input device. Display device 380 can comprise an LCD screen, touchscreen, or other display.

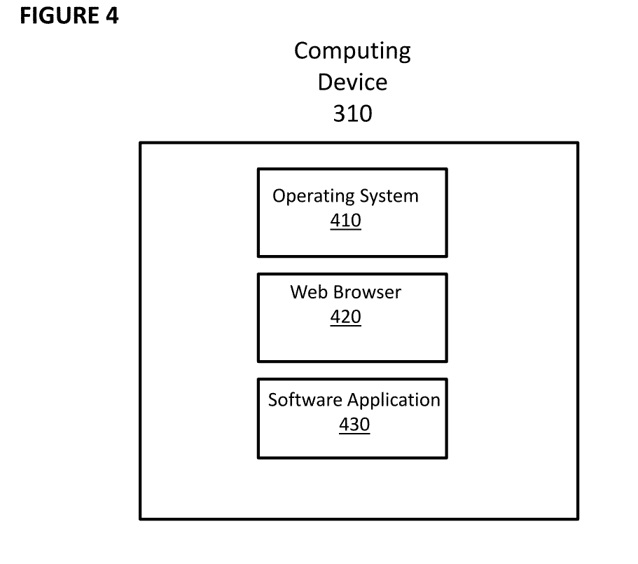

With reference to FIG. 4, software components of computing device 310 are depicted. Computing device 310 comprises operating system 410 (such as Windows, Linux, MacOS, Android, or iOS), web browser 420 (such as Internet Explorer, Chrome, Firefox, and Safari), and software application 430. Operating system 410, web browser 420, and software application 430 each comprise lines of software code that can be stored in memory 340 and executed by processing unit 330.

In the embodiments described below, computing device 110 will act as a server, and computing device 310 will act as a client.

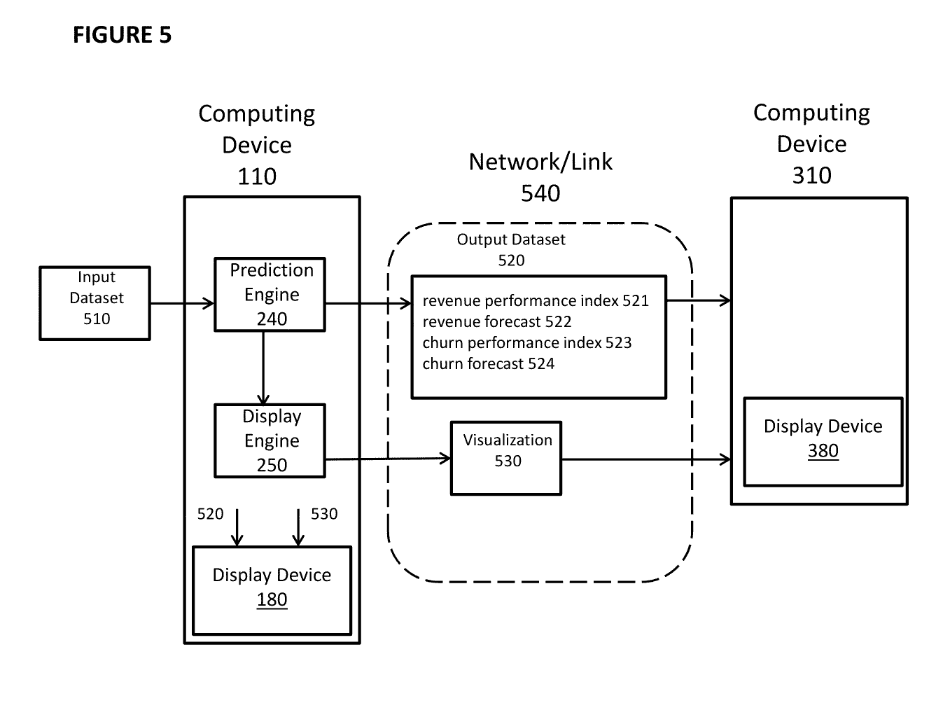

With reference to FIG. 5, computing device 110 and computing device 310 communicate over network/link 540. Network/link 540 can comprise wired portions (e.g., Ethernet) and/or wireless portions (e.g., 3G, 4G, GSM, 802.11), or a link such as USB, Firewire, PCI, etc. Network/link 540 can comprise the Internet, a local area network (LAN), a wide area network (WAN), or other network.

Computing device 110 receives input dataset 510 from data store 120, computing device 310, another computing device, or itself. An example of input dataset 510 is data from a Customer Relationship Management (CRM) database stored on data store 120 that comprises data corresponding to one or more fields for one or more of the following components:
Component 1, Transactions Dataset:
   User ID
   Transaction Date
   Transaction Type
   Product ID
   Response ID
Component 2, Charging Response Dataset:
   Response ID
   Response Description
Component 3, Product Dataset
   Product ID
   Product Name
   Product Category
   Product Supplier
Component 4, User Dataset
   User ID
   Segment
   Acquisitional Channel ID
Component 5, Channel Dataset
   Acquisition Channel ID
   Channel Name
   Channel Category

Computing device 110 uses prediction engine 240 to perform algorithms on input dataset 510 to generate output dataset 520. Computing device 110 also uses visualization engine 250 to generate visualization 530, which comprises a visualization of some or all of output dataset 520 and related data.

Computing device 310 receives output dataset 520 and can provide it to a user, such as by displaying it on display device 380. Computing device 310 also receives visualization 530 and can provide it to a user, such as by displaying in on display device 380. In one embodiment, visualization engine 250 generates a web page that is served by web server 220, and computing device 310 uses web browser 420 to display visualization 530 as a web page or part of a web page. In the alternative, computing device 110 can itself provide output dataset 520 to a user, such as by displaying it on display device 180. Computing device 110 also can provide visualization 530 it to a user, such as by displaying in on display device 180. In one embodiment, visualization engine 250 generates a web page that is served by web server 220 and also displayed by a web browser running on computing device 110 to display visualization 530 as a web page or part of a web page.

As shown in FIG. 5, output dataset 520 can comprise revenue performance index 521, revenue forecast 522, churn performance index 523, and churn forecast 524, discussed in greater detail below.

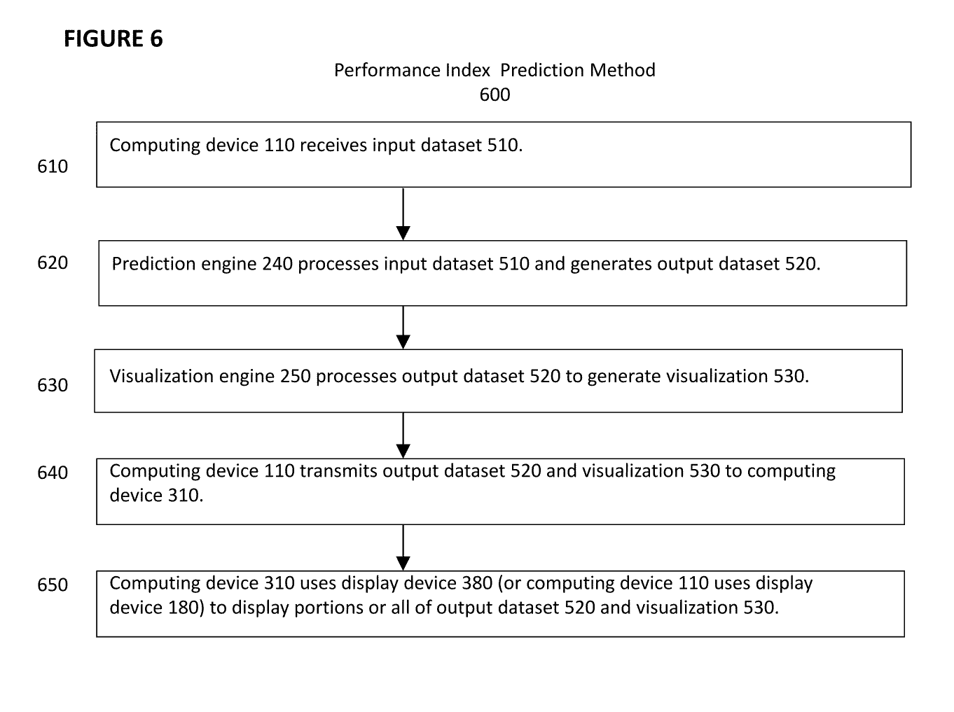

With reference to FIG. 6, performance index prediction method 600 is depicted, using the system of FIG. 5. Computing device 110 receives input dataset 510 (step 610). Prediction engine 240 processes input dataset 510 and generates output dataset 520 (step 620). Visualization engine 250 processes output dataset 520 to generate visualization 530 (step 630). Computing device 110 transmits output dataset 520 and visualization 530 to computing device 310 (step 640). Computing device 310 uses display device 380 (or computing device 110 uses display device 180) to display portions or all of output dataset 520 and visualization 530 (step 650).

Additional detail will now be presented regarding input dataset 510, prediction engine 240, visualization engine 250, and output dataset 520.

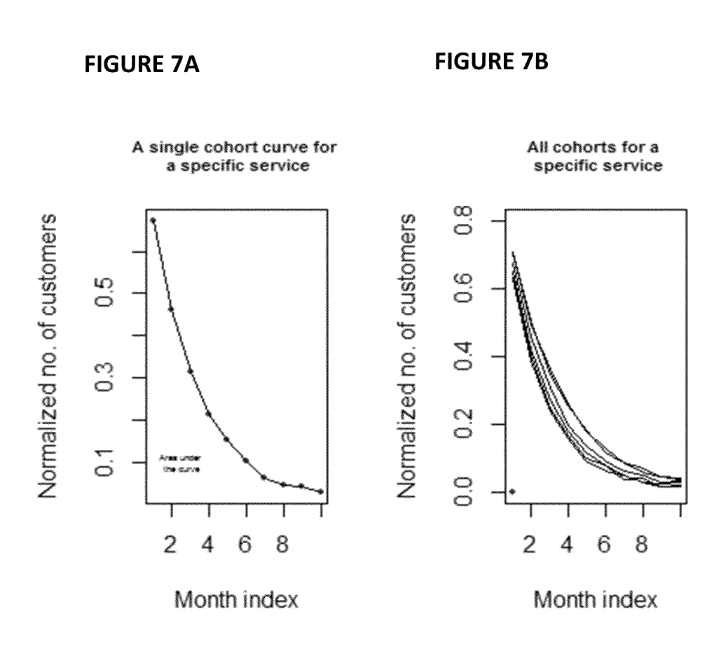

Input dataset 510 in one embodiment comprises data that reflects the previous history of cohorts of customers subscribing to different services and traces their churn rate over periods of time. Each cohort of customers associated with each service is studied alone and the following variables A and Cm are computed:

$$A = {\sum }_{m = 1}^{months} \frac{{S}_{m}}{{S}_{1}}$$

where A is the approximate area under the normalized cohort curve shown in FIG. 7A, Sₘ is the number of subscribers still using the service at month m from the starting month, and S₁ is the number of customers at month number 1.

$$Cm = 1 - \frac{{S}_{m}}{{S}_{1}}$$

where Cm is the subscriber churn rate after month m for that specific cohort of customer subscribed in a specific service.

FIGS. 7A and 7B depict graphs generated from data in input dataset 510. The graph in FIG. 7A shows the normalized number of customers over time, for customers in a single cohort for a specific service (e.g., all customers in California who subscribe to mobile phone plan X starting June 2013). The graph in FIG. 7B shows the normalized number of customers over time (e.g. Months following June 2013 till present month)—, for all cohorts for a specific service (e.g., all California customers who subscribe to mobile phone plan X following June 2013). Note: A Shift Left operation to overlap curves over each other in order to prepare for the next step in the algorithm and to ease the process of Cohort comparison.

For each cohort of customers subscribing to a specific product, both A and C are computed and then for all cohorts for a specific service a grand mean (Ā) and standard deviation (σ_{A}) is computed as follows:

$$\overline{A} = {\sum }_{i = 1}^{No . of . cohorts} \frac{{A}_{i}}{No . of . cohorts}$$

$${σ}_{A} = \sqrt{\frac{1}{No . of . cohorts} {\sum }_{i = 1}^{No . of . cohorts} {( {A}_{i} - \overline{A} )}^{2}}$$

where Ā is the grand mean normalized area under the curve for all cohorts of customers subscribing in a specific service, and σ_{A} is the standard deviation for the normalized mean area under the curve for all cohorts of customers in a specific service.

The same applies on the churn C̅ and σ_{C}. Specifically:

$$\overline{C} = {\sum }_{i = 1}^{No . of . cohorts} \frac{{C}_{i}}{No . of . cohorts}$$

$${σ}_{C} = \sqrt{\frac{1}{No . of . cohorts} {\sum }_{i = 1}^{No . of . cohorts} {( {C}_{i} - \overline{C} )}^{2}}$$

Where C̅ is the grand mean subscribers churn after month m for all cohorts of customers subscribing in a specific service and σ_{C} is the standard deviation for the mean subscriber churn after month m for all cohorts of customers in a specific service.

Revenue performance index 521 and churn performance index 523 are calculated as follows.

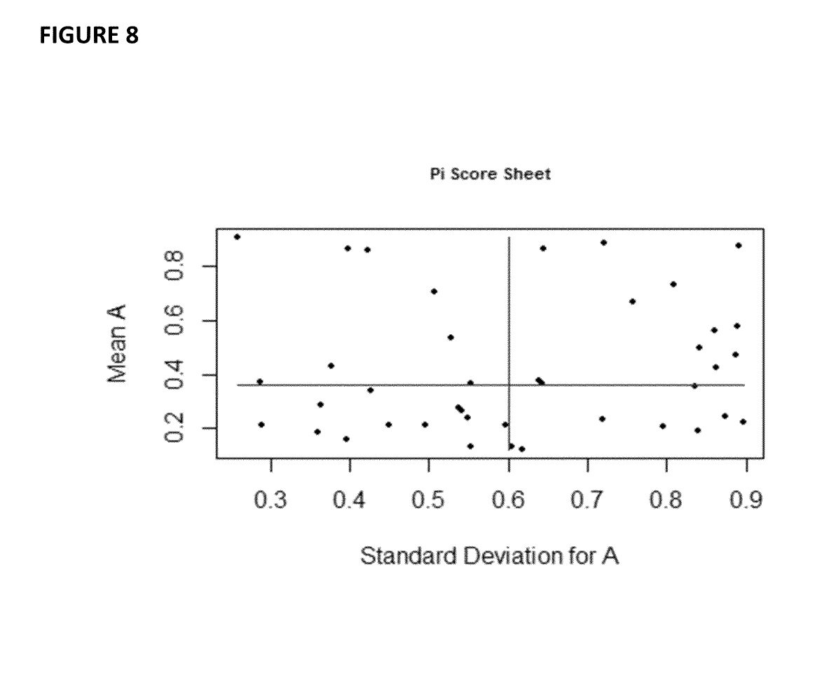

The first step for revenue performance index 521 and churn performance index 523 is to divide and cluster services into for quadrants based on their Ā and their σ_{A}, as shown in FIG. 8. In FIG. 8, Quadrant 1 indicates services that have Ā above the median of Ā (computed over all services) and that have σ_{A} below the median σ_{A} (computed over all services), Quadrant 2 indicates services that have above median of Ā and above median of σ_{A}, Quadrant 3 indicates services that have below median Ā and above median σ_{A}, and Quadrant 4 indicates services that have below median Ā and below median σ_{A}.

Revenue performance index 521 is calculated as follows:

Revenue Performance Index 521=for.each_{q=1}^{No.of.qudarants}(rankᵢ₌₁^{No.of.services}^{_{q}}(A̅_̅{̅q̅i̅}̅))

Pseudo-code for calculating revenue performance index 521 by prediction engine 240 is the following:

for(q in 1:no.of.quadrants) {
for(s in 1:no.of.services.per.quadrant) {

Pi[q,s] = rank(mean_area_under_the_curve)

}
}

Churn performance index 523 is calculated as follows:

Churn Performance Index 521=for.each_{q=1}^{No.of.Equdarants}(rankᵢ₌₁^{No.of.services}^{_{q}}(C̅_̅{̅q̅i̅}̅))

Pseudo-code for calculating churn performance index 523 by prediction engine 240 is the following:

for(q in 1:no.of.quadrants) {
for(s in 1:no.of.services.per.quadrant) {

Pi[q,s] = rank(mean_churn_at_month_m)

}
}

For any product, a forecast for expected revenue to be generated from new customers during the first period (daily, monthly, annually, etc.) can be computed as follow:

Revenue forecast 522=\hat{F}=Ā*Initial subscribers base*flat price per service.

Upper Estimate Bound=UEB=Initial subscribers base*flat price per service*(Ā+3*σ_{A})

Lower Estimate Bound=LEB=Maximum(0,Initial subscribers base*flat price per service*(Ā−3*σ_{A}))

A forecast for churn can be computes as follows:

Mean Churn Percentage forecast 522=Ĉ=C̅*100.

Upper Estimate Bound=UEB=Minimum(1,(C̅+3*σ_{C}))*100

Lower Estimate Bound=LEB=Maximum (0,(C̅−3*σ_{C}))*100

Another embodiment of an algorithm performed by prediction engine 240 to calculate revenue performance index 521 and churn performance index 523 will now be described. Instead of calculating the approximate average normalized area under the curve as in the first embodiment, the second embodiment uses an exponential smoothing technique that assigns more weight to the most recent cohorts than to earlier cohorts. The formula for the smoothed Area calculation is:

Aₜ=αAₜ₋₁+α(1−α)Aₜ₋₂+α(1−α)²Aₜ₋₂+ . . . +α(1−α)^{t-1}A₁

where Aₜ is the smoothed area at time t (which is the current time where the calculation is carried-on), Aₜ₋₁ is the normalized area for the most recent cohort, A₁ is the normalized area for the first cohort, and α is the attenuation factor.

The formula for the smoothed Churn calculation:

Cₜ=αCₜ₋₁+α(1−α)Cₜ₋₂+α(1−α)²Cₜ₋₂+ . . . +α(1−α)^{t-1}C₁

where Cₜ is the smoothed churn at time t (which is the current time where the calculation is carried-on), Cₜ₋₁ is the normalized area for the most recent cohort, C₁ is the normalized area for the first cohort, and α is the attenuation factor.

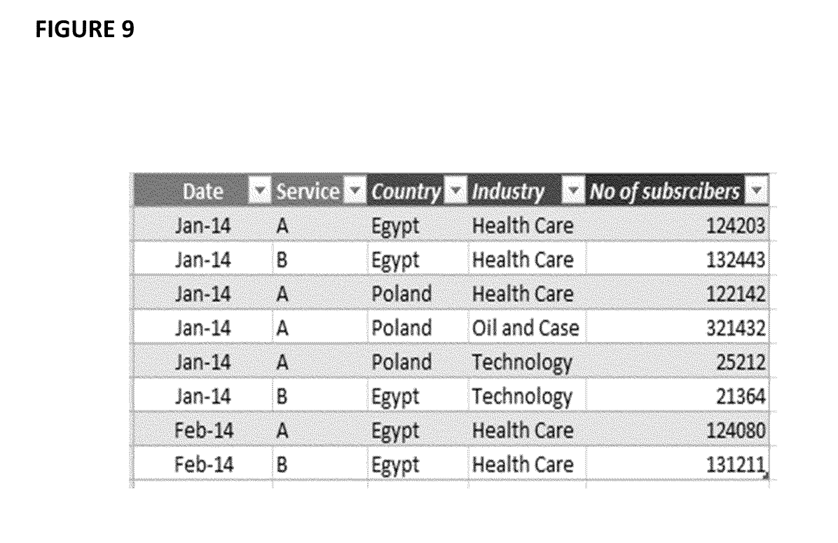

In another embodiment, a service performance miner module is utilized by computing device 110 and operates on the data generated by prediction engine 240. The service performance miner module implements different data mining techniques for identifying the factors within the Metadata that if adopted as a strategy for customer acquisition will yield higher chance of high incremental revenue return. Typical service data used for input dataset 510 usually comes not only with the number of subscribers per month that is used as the basis for calculating revenue performance index 521, but comes with other meta-data that is relevant to the subscriber or the subscriber transaction itself. An example of a subset of the raw data that may be included in input dataset 510 is depicted in FIG. 9.

The service performance mining module implements different data mining techniques for determining the factors within the metadata that, if adopted as a strategy for customer acquisition, will yield a higher chance of high incremental revenue return. For example:
What is the best geographical region have the most potential?
What is the best acquisition channel associated with excellent/high potential services?
Is there any specific industry in Poland that is associated with poor services?

Those types of questions are answered using the service performance mining module. Algorithms used for mining data are known in the prior art and include but are not limited to the following algorithms:
Multinomial logistic regression
Recursive Partitioning and Regression Trees
Random Forest
Support Vector Machines
Boosting

The output of that module which is mainly developed using open source R packages will be either represented as a tree that explain which meta-data factors are impacting each quadrant the most, or as a set of rules that guide to the same conclusions.

For example, applying any of the above algorithms may suggest that if we focus on services sold to Customers in Poland we will expect that our services will be performing excellent (i.e. Quadrant—1), while in other countries services will either be performing normally except in the health care industry where services will experience a high chance of performing poorly.

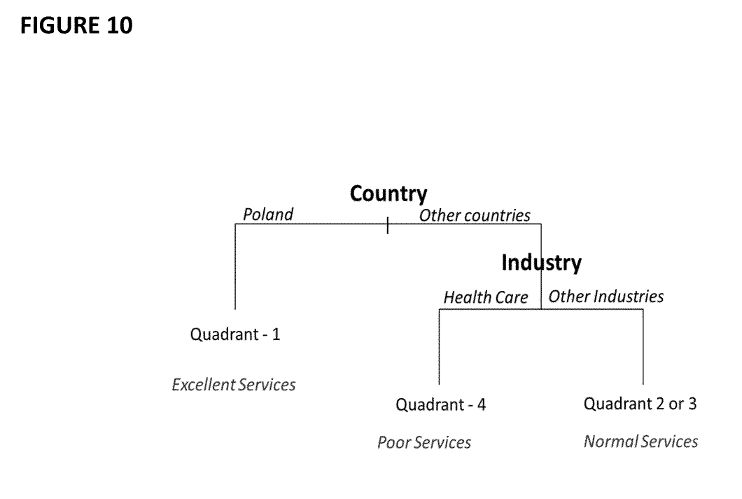

An example of the use of recursive partitioning and regressions trees is found in FIG. 10.

The other format will be expressed as rules in a text format:

Rule 1:

IF [country]==“Poland” Then P_{q1} is the highest.

Rule 2:

IF [country] !=“Poland” AND [industry]==“Health Care” Then Pₐ₄ is the highest.

Rule 3:

IF [country] !=“Poland” AND [industry] !=“Health Care” Then P_{q3} is the highest.

where P_{q1}, P_{q2}, P_{q3}, and P_{q4} are the probability that services will lay in quadrant 1, 2, 3, or 4 respectively.

In another embodiment, a projection module by computing device 110 to use the data from prediction engine 240 to run different scenarios mixing meta-data and obtaining the probabilities of each quadrant for those scenarios.

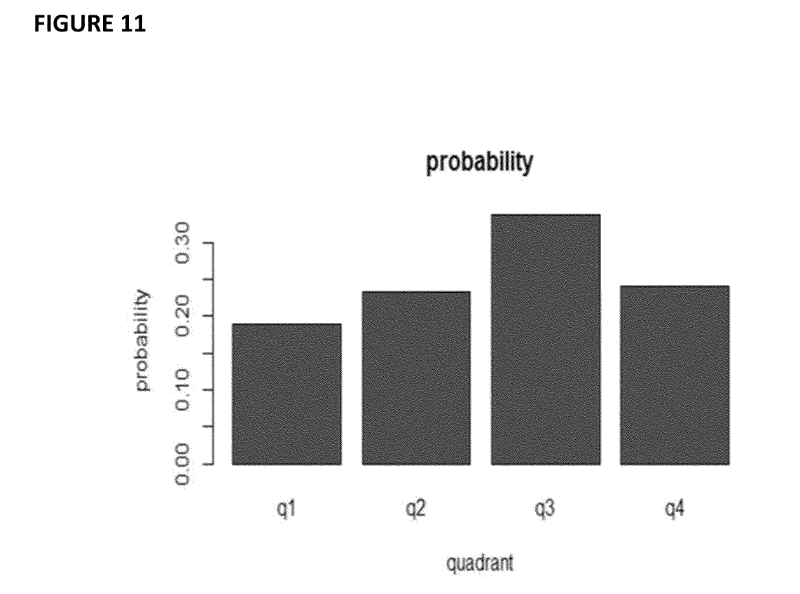

For example, if a customer wants to try: Services in Poland, within the industry “Agriculture & forestry” using the “Outbound Team, Tier 1” channel for companies with size “1000+” what is the likelihood probability that such service will exists in each quadrant. Possible results are shown in FIG. 11.

References to the present invention herein are not intended to limit the scope of any claim or claim term, but instead merely make reference to one or more features that may be covered by one or more of the claims. Materials, processes and numerical examples described above are exemplary only, and should not be deemed to limit the claims. It should be noted that, as used herein, the terms “over” and “on” both inclusively include “directly on” (no intermediate materials, elements or space disposed there between) and “indirectly on” (intermediate materials, elements or space disposed there between). Likewise, the term “adjacent” includes “directly adjacent” (no intermediate materials, elements or space disposed there between) and “indirectly adjacent” (intermediate materials, elements or space disposed there between).

What is claimed is:

1. A method for determining expected revenue and churn for a set of new subscribers of a recurring revenue product, comprising:
receiving, by a computing device comprising a prediction engine and a visualization engine, an input dataset; and
processing, by the prediction engine, the input dataset to generate an output dataset comprising a revenue forecast for the set of new subscribers and a churn forecast for the set of new subscribers.

2. The method of claim 1, further comprising:
processing, by the visualization engine, the output dataset to generate a visualization.

3. The method of claim 1, further comprising:
displaying, by the computing device, at least part of the output dataset.

4. The method of claim 2, further comprising:
displaying, by the computing device, at least part of the output dataset and at least part of the visualization.

5. The method of claim 1, further comprising:
transmitting, by the computing device, the output dataset to a second computing device; and
displaying, by the second computing device, at least part of the output dataset.

6. The method of claim 2, further comprising:
transmitting, by the computing device, the output dataset and the visualization to a second computing device; and
displaying, by the second computing device, at least part of the output dataset and at least part of the visualization.

7. The method of claim 6, wherein the displaying step comprises displaying a web page by a web browser operated by the second computing device.

8. A method for generating expected revenue to be generated from new customers of a recurring revenue product during a time period, comprising:
receiving, by a computing device comprising a prediction engine and a visualization engine, an input dataset, the input dataset comprising data for a plurality of cohorts, each cohort comprising a plurality of subscribers of the recurring revenue product;
determining, by the prediction engine, a value A according to the formula:
$$A = {\sum }_{m = 1}^{months} \frac{{S}_{m}}{{S}_{1}}$$
where Sₘ is the number of subscribers still using the service at month m from the starting month, and Sᵢ is the number of customers at month number 1, and where Sₘ and Sᵢ are determined from the input dataset;
determining, by the prediction engine, a value Ā according to the formula:
$$\overline{A} = {\sum }_{i = 1}^{No . of . cohorts} \frac{{A}_{i}}{No . of . cohorts}$$
determining, by the prediction engine, an expected revenue to be generated from new subscribers of the recurring revenue product according to the formula: expected revenue=Ā*Number of New Subscribers*Flat Price Charged Per Recurring Revenue Product.

9. The method of claim 8, further comprising:
determining, by the prediction engine, a value σ_{A} according to the formula:
$${σ}_{A} = \sqrt{\frac{1}{No . of . cohorts} {\sum }_{i = 1}^{No . of . cohorts} {( {A}_{i} - \overline{A} )}^{2}}$$
determining, by the prediction engine, an upper estimate bound according to the formula: upper estimate bound=initial subscribers base*flat price per service*(Ā+3*σ_{A}); and
determining, by the prediction engine, a lower estimate bound according to the formula: lower estimate bound=Maximum (0, Initial subscribers base*flat price per service*(Ā−3*σ_{A})).

10. The method of claim 8, further comprising:
processing, by the visualization engine, the expected revenue to generate a visualization.

11. The method of claim 10, further comprising:
displaying, by the computing device, the expected revenue and at least part of the visualization.

12. The method of claim 8, further comprising:
transmitting, by the computing device, the expected revenue to a second computing device; and
displaying, by the second computing device, the expected revenue.

13. The method of claim 10, further comprising:
transmitting, by the computing device, the expected revenue and the visualization to a second computing device; and
displaying, by the second computing device, the expected revenue and at least part of the visualization.

14. The method of claim 13, wherein the displaying step comprises displaying a web page by a web browser operated by the second computing device.

15. A method for generating an expected churn of new customers of a recurring revenue product during a time period, comprising:
receiving, by a computing device comprising a prediction engine and a visualization engine, an input dataset, the input dataset comprising data for a plurality of cohorts, each cohort comprising a plurality of subscribers of the recurring revenue product;
determining, by the prediction engine, values Cm according to the formula:
$$Cm = 1 - \frac{{S}_{m}}{{S}_{1}}$$
where m ranges from 1 to the number of cohorts, Sₘ is the number of subscribers still using the service at month m from the starting month, and Sᵢ is the number of customers at month number 1, and where Sₘ and Sᵢ are determined from the input dataset;
determining, by the prediction engine, a value C̅ according to the formula:
$$\overline{C} = {\sum }_{i = 1}^{No . of . cohorts} \frac{{C}_{i}}{No . of . cohorts}$$
determining, by the prediction engine, an expected churn of new subscribers of the recurring revenue product according to the formula: expected churn=C̅*100.

16. The method of claim 15, further comprising:
determining, by the prediction engine, a value σ_{C} according to the formula:
$${σ}_{C} = \sqrt{\frac{1}{No . of . cohorts} {\sum }_{i = 1}^{No . of . cohorts} {( {C}_{i} - \overline{C} )}^{2}}$$
determining, by the prediction engine, an upper estimate bound according to the formula: upper estimate bound=Minimum (1, (C̅+3*σ_{C}))*100; and
determining, by the prediction engine, a lower estimate bound according to the formula: lower estimate bounds=Maximum (0, (C̅−3*σ_{C}))*100.

17. The method of claim 15, further comprising:
processing, by the visualization engine, the expected churn to generate a visualization.

18. The method of claim 17, further comprising:
displaying, by the computing device, the expected churn and at least part of the visualization.

19. The method of claim 15, further comprising:
transmitting, by the computing device, the expected churn to a second computing device; and
displaying, by the second computing device, the expected churn.

20. The method of claim 17, further comprising:
transmitting, by the computing device, the expected churn and the visualization to a second computing device; and
displaying, by the second computing device, the expected churn and at least part of the visualization.

21. The method of claim 20, wherein the displaying step comprises displaying a web page by a web browser operated by the second computing device.
